(19) United States
(12) Patent Application Publication
(10) Pub. No.: US 2026/0163230 A1
(43) Pub. Date: Jun. 11, 2026

(54) CELLULAR BASE STATION ASSEMBLIES WITH ADAPTERS TO INTERCONNECT ANTENNA AND RRU

(71) Applicant: Outdoor Wireless Networks LLC, Richardson, TX (US)

(72) Inventors: Chen Chen, Suzhou, Jiangsu (CN); Junfeng Yu, Suzhou, Jiangsu (CN)

(21) Appl. No.: 19/105,077

(22) PCT Filed: Aug. 2, 2023
(86) PCT No.: PCT/US2023/071486

§ 371 Date: Feb. 20, 2025

(30) Foreign Application Priority Data
Aug. 30, 2022 (CN) 202211047633.9

(51) Int. Cl. H01Q 1/24; H01Q 1/12; H04W 88/08

(52) U.S. Cl. CPC H01Q 1/246; H01Q 1/1242; H04W 88/085

(57) ABSTRACT

A cellular base station antenna assembly includes: a telecommunications antenna with plurality of first communication ports mounted on a rear surface thereof; a remote radio unit mounted to the antenna having a plurality of second communication ports on a lower surface thereof; and an adapter configured to connect the remote radio unit to the antenna, the adapter including a housing, a first clustered connector that includes a plurality of individual first connectors, the first clustered connector being mounted on a lower portion of the housing, the adapter further including a plurality of second connectors mounted on an upper surface of the housing, each of the first connectors being connected with a respective second connector. Each of the second connectors is mated with a respective second communication port, and each of the first connectors is mated with a respective first communication port. The assembly further includes a disengagement mechanism connected to the assembly and configured to raise the remote radio unit relative to the adapter to disengage the second connectors from the second communication ports.

### RELATED APPLICATION

The present application claims priority from and the benefit of Chinese Patent Application No. 202211047633.9, filed Aug. 30, 2022, the disclosure of which is hereby incorporated herein by reference in full.

### FIELD OF THE INVENTION

The present invention is directed generally toward antennas, and more particularly to mounting structures for antennas.

### BACKGROUND OF THE INVENTION

As wireless data service demands have grown, a conventional response has been to increase the number and capacity of conventional cellular Base Stations (Macro-Cells). The antennas used by such Macro-Cells are typically mounted on antenna towers. A conventional antenna tower has three or four legs on which antennas and supporting remote radio units (RRUs) are mounted. However, in some environments structures known as “monopoles” are used as mounting structures. Monopoles are typically employed when fewer antennas/RRUs are to be mounted, and/or when a structure of less height is required.

As Macro-Cell sites have become less available, and available spectrum limits how much additional capacity can be derived from a given Macro-Cell, small cell RRU and antenna combinations have been developed to “fill in” underserved or congested areas that would otherwise be within a Macro-Cell site. Deployment of small cells, particularly in urban environments, is expected to continue to grow. Often such small cell configurations (sometimes termed “Metrocells”) are mounted on monopoles.

Traditionally, antennas and RRUs have been separate pieces of equipment, and are connected via jumper cables or the like. In such instances, the antennas are considered “passive,” in that the signals are generated and received by the RRUs. In a passive antenna array, an array of radiating elements is configured to generate static antenna beams that have a fixed shape (except for occasional changes to the electronic downtilt angle of the antenna beams) in response to RF signals received from an external radio. The antenna beams generated by a passive antenna array are typically designed to provide coverage to a desired area, such as a sector (e.g., a 120° sector in the azimuth plane) of a cell. This arrangement has commonly been the case up to and including “4G” RRUs and antennas, which meet the standards for “4G” communications.

Such an arrangement is exemplified in FIG. 1, wherein two RRUs 20 are mounted to the rear surface of an antenna 10. In this instance, sliding rails 30 are employed to mount the RRUs 20 onto the antenna 10. Cables 40 are routed from multiple ports on each RRU 20 to ports on the antenna 10. While this arrangement is operable, one potential shortcoming is that the cables 40 are exposed. In addition, the cables 40 and their associated connectors are connected one-by-one between the ports of the RRUs 20 and the ports of the antenna 10, which can be labor intensive and can introduce the possibility for error in routing. Thus, it may be desirable to provide an alternative solution for mounting and connecting RRUs and passive antennas.

### SUMMARY

As a first aspect, embodiments of the invention are directed to a cellular base station antenna assembly comprising: a telecommunications antenna with plurality of first communication ports mounted on a rear surface thereof; a remote radio unit mounted to the antenna having a plurality of second communication ports on a lower surface thereof; and an adapter configured to connect the remote radio unit to the antenna, the adapter including a housing, a first clustered connector that includes a plurality of individual first connectors, the first clustered connector being mounted on a lower portion of the housing, the adapter further including a plurality of second connectors mounted on an upper surface of the housing, each of the first connectors being connected with a respective second connector. Each of the second connectors is mated with a respective second communication port, and each of the first connectors is mated with a respective first communication port. The assembly further comprises a disengagement mechanism connected to the assembly and configured to raise the remote radio unit relative to the adapter to disengage the second connectors from the second communication ports.

As a second aspect, embodiments of the invention are directed to a cellular base station antenna assembly comprising: a telecommunications antenna having a plurality of first communication ports mounted on a rear surface thereof; a remote radio unit mounted to the antenna having a plurality of second communication ports on a lower surface thereof; and an adapter configured to connect the remote radio unit to the antenna, the adapter including a first clustered connector that includes a plurality of individual first connectors, the adapter further including a plurality of second connectors, each of the first connectors being connected with a respective second connector by a respective cable. Each of the second connectors is mated with a respective second communication port, and each of the first connectors is mated with a respective first communication port. The assembly further comprises a cover mounted to the antenna that encloses the cables, the second clustered connector and the first connectors. The assembly also comprises a disengagement mechanism connected to the assembly and configured to raise the remote radio unit relative to the adapter to disengage the second connectors from the second communication ports.

### BRIEF DESCRIPTION OF THE FIGURES

FIG. 1 is a perspective view of an antenna assembly in which an RRU is mounted on an antenna.

FIG. 2 is a side view of a cellular base station antenna assembly according to embodiments of the invention.

FIG. 3 is a rear perspective view of the assembly of FIG. 2.

FIG. 4 is a top rear perspective view of the adapter of the assembly of FIG. 2.

FIG. 5 is an exploded view of the RRU, adapter and upper mounting bracket of the assembly of FIG. 2.

FIG. 6 is a perspective view of the RRU and adapter of the assembly of FIG. 2.

FIG. 7 is a top perspective view of an adapter according to alternative embodiments of the invention.

FIG. 8 is a bottom perspective view of the adapter of FIG. 7.

FIG. 9 is a exploded perspective view of the RRU and adapter of FIG. 7.

FIG. 10 is a side view of an assembly according to alternative embodiments of the invention.

FIG. 11 is a perspective view of the assembly of FIG. 10.

FIG. 12 is an exploded perspective view of the RRU, upper mounting bracket, and lower mounting bracket of the assembly of FIG. 10.

FIG. 13 is an assembled perspective view of the RRU, upper mounting bracket and lower mounting bracket of the assembly of FIG. 10.

FIG. 14 is an exploded perspective view of the RRU, upper mounting bracket and an alternative lower mounting bracket for the assembly of FIG. 10.

FIG. 15 is a side perspective view of the antenna of the assembly of FIG. 10 mounted on a mounting pole.

FIG. 16 is a partial rear perspective view of the adapter of FIG. 10 prior to mounting on the antenna.

FIG. 17 is a partial rear perspective view of the adapter of FIG. 10 mounted on the antenna.

FIG. 18 is a top perspective view of the assembly of FIG. 10.

FIG. 19 is a rear perspective view of an alternative adapter for the assembly of FIG. 10.

FIG. 20 is a front perspective view of the adapter of FIG. 19.

FIG. 21 is a rear perspective view of the adapter of FIG. 19 mounted on the antenna.

FIG. 22 is a rear perspective view of an assembly according to further embodiments of the invention.

FIG. 23 is a bottom rear perspective view of the RRU of the assembly of FIG. 22.

FIG. 24 is a rear perspective view of the antenna of the assembly of FIG. 22.

FIG. 25 is a rear perspective view of the adapter of the assembly of FIG. 22.

FIG. 26 is a rear perspective view of the cover of the assembly of FIG. 22.

FIG. 27 is a rear perspective of an assembly according to further embodiments of the invention.

FIGS. 28A-28C are rear perspective views of the assembly of FIG. 27 illustrating how an RRU is removed from the antenna.

FIGS. 29A and 29B are side views illustrating the rest and lifted positions of the disengagement mechanism of the assembly of FIG. 27.

FIG. 30 is a side rear perspective view of the assembly of FIG. 27 illustrating the mounting of the adapter on the antenna.

FIGS. 31A and 31B are rear side exploded perspective views of the assembly of FIG. 27 illustrating the mounting of the lower end of the RRU on the adapter.

FIG. 32 is a rear perspective view of the upper end of the RRU and antenna of the assembly of FIG. 27.

FIG. 33A is a perspective view of a PIM-reducing insert for the assembly of FIG. 27. FIGS. 33A and 33B are rear side perspective views of the lower end of the adapter and the cluster connector with the insert in place.

FIG. 34 is a rear perspective view of the assembly of FIG. 27 showing that one or two RRUs may be mounted on the same antenna.

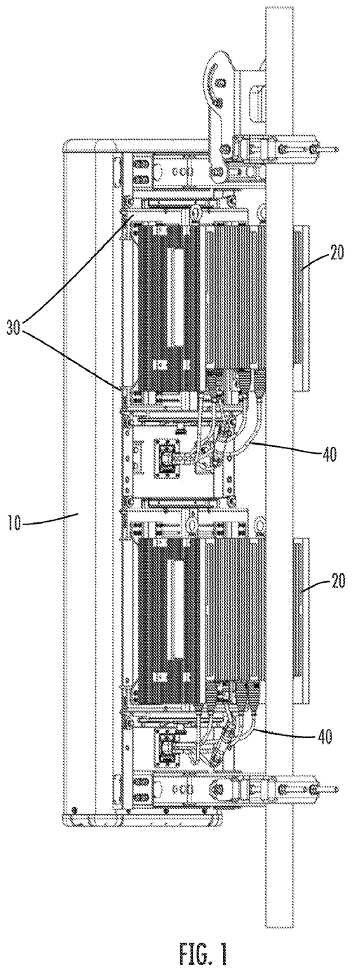

### DETAILED DESCRIPTION OF THE INVENTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

As used herein, phrases such as “between X and Y” and “between about X and Y” should be interpreted to include X and Y. As used herein, phrases such as “between about X and Y” mean “between about X and about Y”. As used herein, phrases such as “from about X to Y” mean “from about X to about Y”.

Well-known functions or constructions may not be described in detail for brevity and/or clarity.

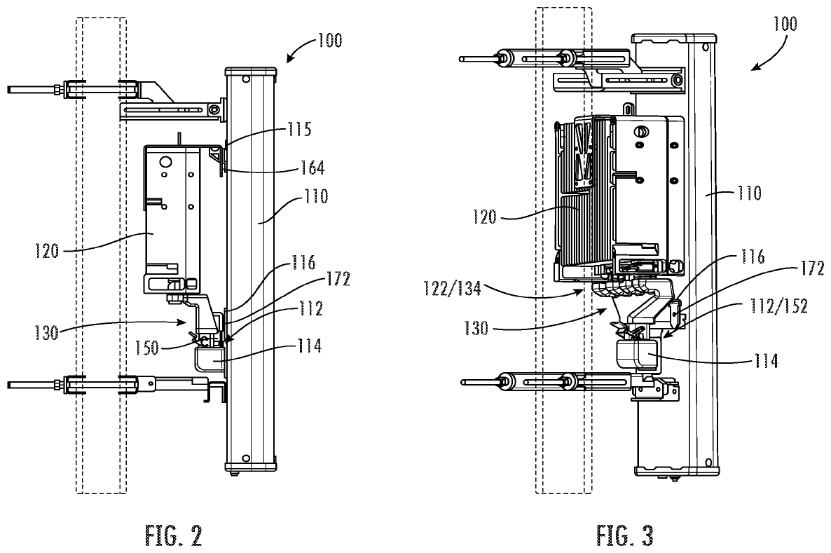

Referring now to FIGS. 2-6, an antenna assembly 100 is shown therein. The assembly 100 includes an antenna 110, an RRU 120, and an adapter 130 that facilitates connection of the communication ports 122 of the RRU to the communication ports 112 of the antenna 110. The RRU 120 can be of conventional construction and need not be described in greater detail herein. An exemplary RRU is a 4G RRU available from Zilink.

The antenna 110 may also be of conventional construction (e.g., a passive 4G antenna), with the exception that the ports 112 of the antenna 110 are located on the upper surface of a block 114 that extends from the rear surface of the antenna 110. Within the block 114, the ports 112 (which face upwardly and therefore are accessible from above) are arranged to receive a ganged or clustered connector 150 (mounted on the lower end of the adapter 130) that enables the connection of all of the ports 112 at once.

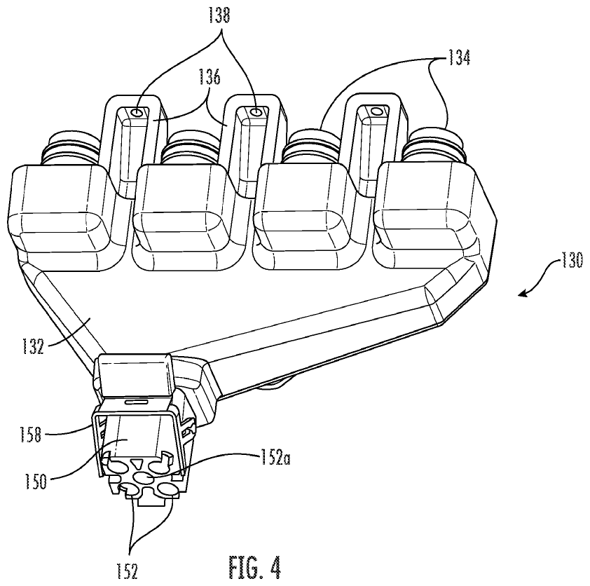

The adapter 130 (shown in FIG. 4) has a housing 132 that is generally triangular in shape. At its upper end, the adapter 130 has connectors 134 that are arranged to connect with the ports 122 of the RRU 120. The connectors 134 and ports 122 are configured as “blind-mated connectors,” thus allowing all of the connectors 134 to be slid into place in the ports 122 at once. In the illustrated embodiment, the connectors 134 and ports 122 follow the convention prescribed by IEC (46F/243/NP) and are commonly known as “4.3/10” connectors. The upper end of the housing 132 also includes channeled fingers 136 with mounting holes 138 that extend upwardly between adjacent connectors 134.

At its lower end, the adapter 130 includes the aforementioned clustered connector 150. In the illustrated embodiment, the individual connectors 152 of the clustered connector 150 are arranged in a square pattern, and may include a connector 152a in the center of the square. Details and advantages of this clustered connector arrangement and others (e.g., a clustered connector in which all connectors are in-line) are described, for example, in U.S. Pat. No. 10,950,970; U.S. Patent Publication No. 2021/0098950; and U.S. patent application Ser. No. 17/496,835, the disclosures of which are hereby incorporated by reference herein in full. Like the connectors 134, the connectors 152 are blind-mated connectors, which allows them to slide into place to connect with the ports 112 of the antenna 110. Exemplary clustered connectors include the MLOC™ family of connectors, available from CommScope, Inc. (Hickory, North Carolina). Although not explicitly shown, it will be understood that the connectors 134 are connected to the connectors 152 via wires, cables or the like that are internal to and enclosed by the housing 132.

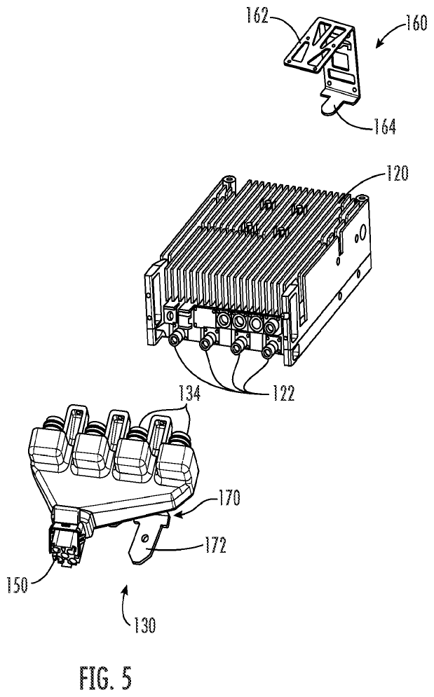

As can be seen in FIG. 5, an upper mounting backet 160 is mounted to the upper end of the RRU 120. The upper mounting bracket 160 has a mounting panel 162 that is fixed via screws or the like to the rear surface of the RRU 120, and further has a downwardly-extending finger 164 that is located in front of the RRU 120. A lower mounting bracket 170 with a downwardly-extending finger 172 is mounted to the front surface of the adapter 130.

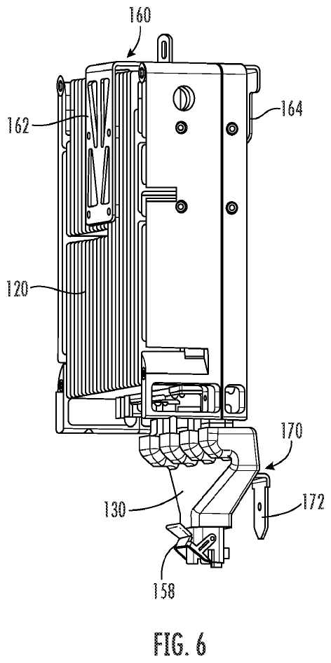

Installation of the RRU 120 onto the antenna 110 begins with the attachment of the adapter 130 to the lower end of the RRU 120 (FIG. 6). More specifically, the connectors 134 of the adapter 130 are blind mated with the ports 122 of the RRU 120 by sliding the adapter 130 upwardly relative to the RRU 120. This action also positions the fingers 136 of the adapter 130 between the ports 122. The adapter 130 can be secured in place via screws inserted into the mounting holes 138 and into threaded holes in the RRU 120.

Once the adapter 130 has been attached to/mated with the RRU 120, the adapter 130 and RRU 120 can together be mounted on the antenna 110 (see FIGS. 2 and 3). More specifically, the antenna 110 includes upper and lower slotted brackets 115, 116 on its rear surface. The RRU 120 and adapter 130 are positioned relative to the antenna 110 so that the finger 164 of the upper mounting bracket 160 and the finger 172 of the lower mounting bracket 170 are above, respectively, the upper and lower slotted brackets 115, 116 of the antenna 110. The RRU 120 and adapter 130 can then be lowered to insert the fingers 164, 172 into the slots in the upper and lower slotted brackets 115, 116. This lowering action also causes the clustered connector 150 of the adapter 130 to be lowered onto the block 114 of the antenna, such that the connectors 152 of the clustered connector 150 blind mate with the ports 112 of the antenna 110. In the illustrated embodiment, the clustered connector 150 includes a locking handle 158 (see FIG. 4) that can be pivoted to engage a pin or the like on the block 114 to lock the clustered connector 150 to the block 114 and ensure proper connection of the connectors 152 with the ports 112.

It can be seen that this arrangement provides a simple technique for mounting the RRU 120 onto the antenna 110, simplifies the interconnection of the ports 122 of the RRU to the ports 112 of the antenna 110, and provides covering/protection for cables used to interconnect the ports 112, 122. Further, the use of the adapter 130 can greatly facilitate the replacement or retrofitting of a radio on an antenna.

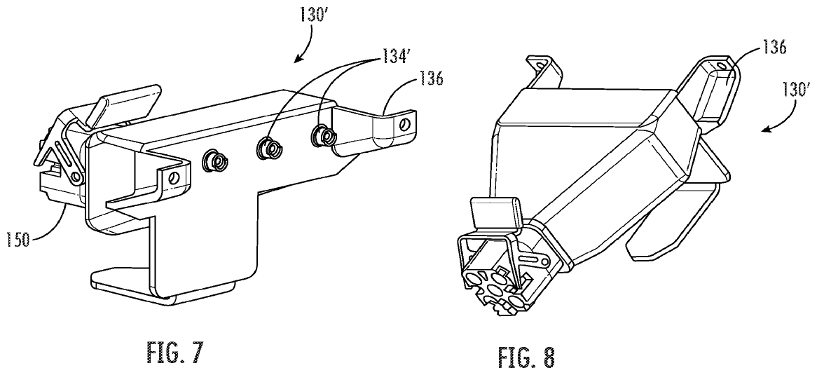

An alternative assembly 100′ is shown in FIGS. 7-9, wherein the RRU 120′ has ports 122′ that conform to the “NEX10” convention recognized in the industry rather than the 4.3/10 configuration of the RRU 120 (such an RRU is available from Nokia). An adapter 130′ is similar to the adapter 130, but includes NEX 10-compatible connectors 134′ rather than 4.3/10 connectors, and has L-shaped flanges 136 for mounting the adapter 130′ to the RRU 120′. The locations of the connectors 134′ may be varied to accommodate different RRU configurations. The installation of the adapter 130′ onto the RRU 120′ is similar to that described above; the adapter 130′ is slid into place to blind mate the connectors 134′ with the ports 122′, and the adapter 130′ is secured to the RRU′ via screws inserted through holes in the flanges 136′ and holes in the RRU 120′. The RRU 120′ and the adapter 130′ are then together mounted on the antenna 110 as described above.

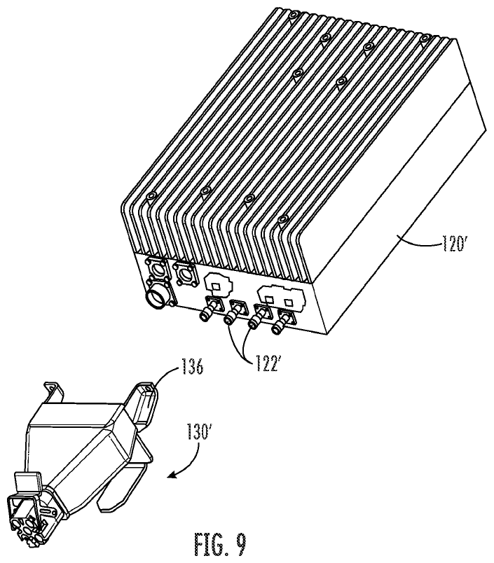

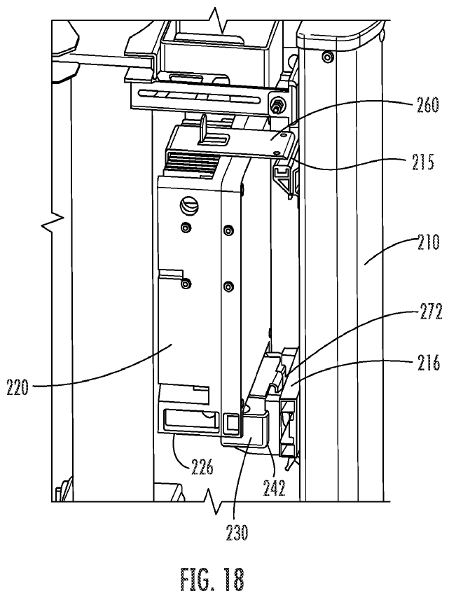

Referring now to FIGS. 10-13 and 15-21, another assembly according to embodiments of the invention is shown therein and designated broadly at 200. The assembly 200 includes an antenna 210 and an RRU 220 that are similar to the antenna 110 and RRU 120 described above, with the exception that the ports 212 of the antenna 210 are mounted to the rear surface of the antenna 210 and face rearwardly (rather than being mounted in a block and facing upwardly).

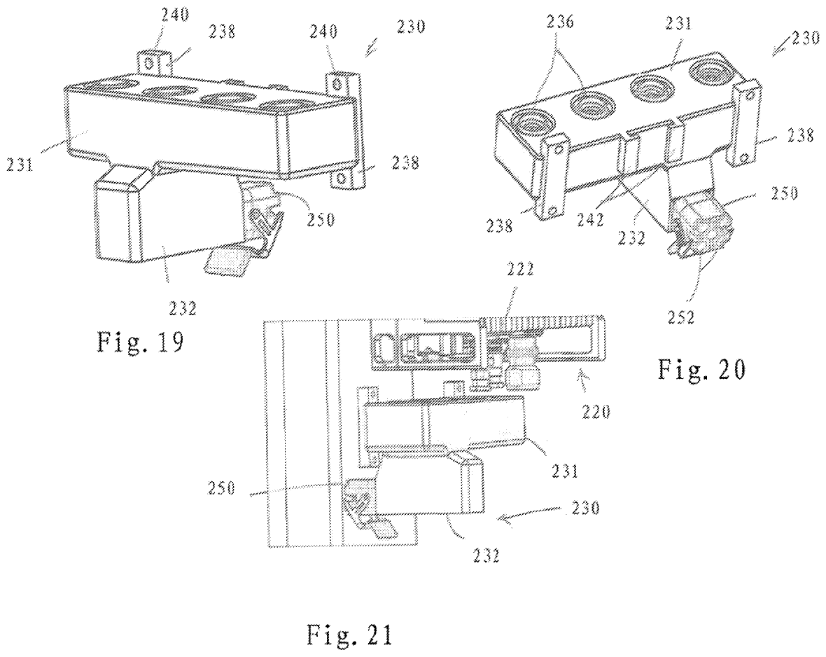

The assembly 200 also includes an adapter 230 (see FIGS. 19 and 20) that is used to connect the ports 222 of the RRU 220 to the ports 212 of the antenna 210, but the adapter 230 is configured somewhat differently from the adapters 130, 130′. The adapter 230 is generally configured as two rectangular blocks 231, 232 that are oriented to be perpendicular with each other. The upper block 231 houses connectors 236 that are configured to mate with the ports 222 of the RRU 220 and that are accessible from above. The upper block also includes flanges 238 on its forward lateral edges with mounting holes 240, and vertical guide rails 242 positioned between the flanges 238. A clustered connector 250 with individual connectors 252 is mounted on the forward end of the lower block 232. As with the adapters 130, 130′, cables or wires are included in the interior of the adapter 230 to interconnect the connectors 236 with the individual connectors 252 of the clustered connector 250.

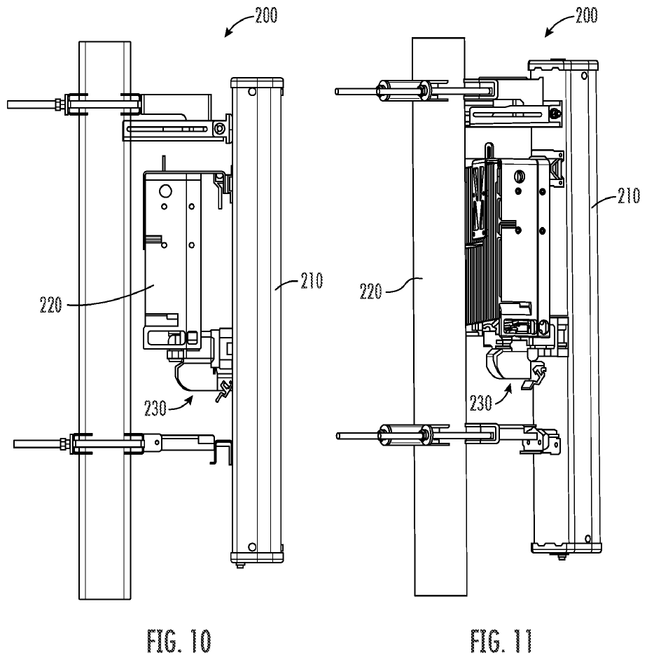

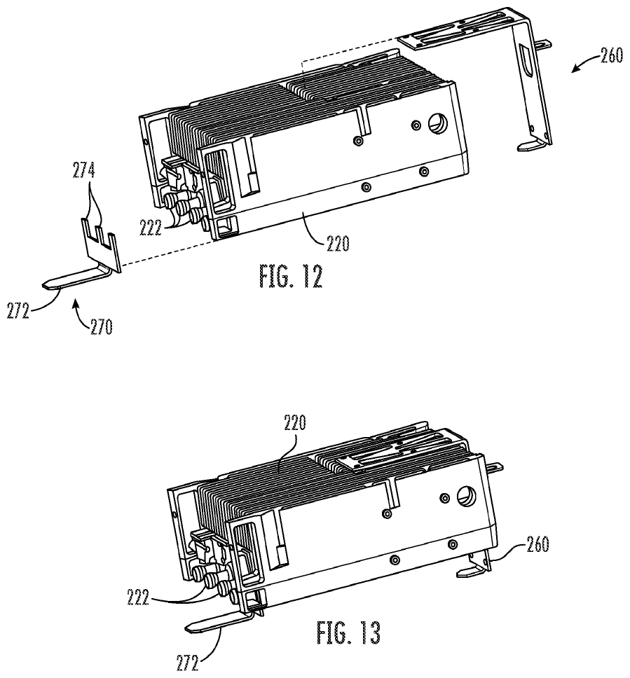

As shown in FIGS. 12 and 13, an upper mounting bracket 260 similar to the upper mounting bracket 160 is mounted to the rear surface of the RRU 220. An L-shaped lower mounting bracket 270 is mounted to the lower surface of the RRU 220; the lower mounting bracket 270 has a downwardly-extending finger 272, and also includes three tines 274 that extend between the ports 222 of the RRU 220.

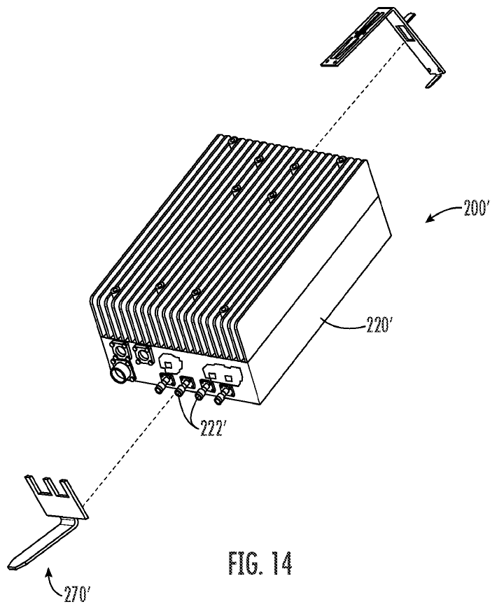

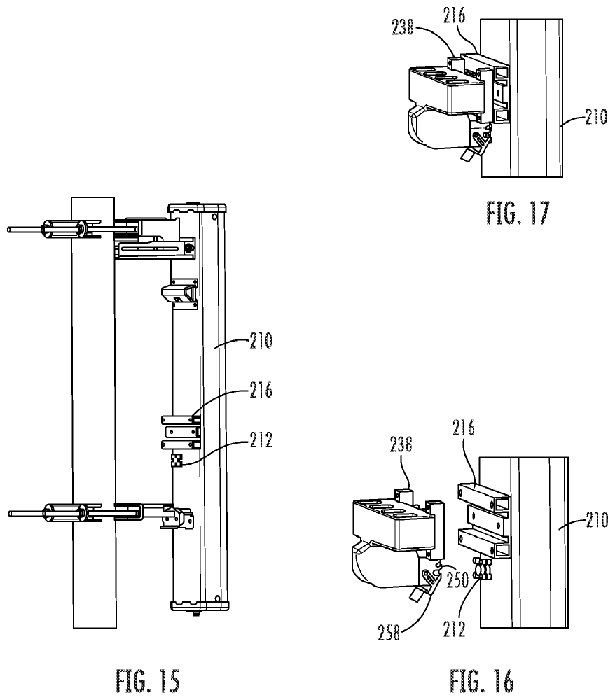

Installation proceeds by mounting the adapter 230 to the antenna 210 (FIGS. 15-17). Specifically, the adapter 230 is fixed to a lower bracket 216 of the antenna 210 with screws or the like inserted into the mounting holes 240 in the flanges 238. This action also blind mates the individual connectors 252 of the cluster connector 250 with the ports 212 of the antenna 210. The locking handle 258 of the cluster connector 250 can be used to locking the connectors 252 to the ports 212.

Once the adapter 230 is fixed to the antenna 210, the RRU 220 can then be lowered onto the adapter 230 (see FIGS. 10, 11 and 18). The finger 262 of the upper mounting bracket 260 is slipped into the slot of the upper bracket 215 of the antenna 210. The finger 272 of the lower mounting bracket 270 is slipped into the guide rails 242 in the adapter 230. Blind mating of the connectors 236 of the adapter 230 with the ports 222 of the RRU 220 occurs when the RRU 220 is fully lowered. Extensions 226 on the RRU 220 can also engage the upper block 231 to help to support and guide the RRU 220 into place. (Alternatively, the RRU 220 may be mounted to the antenna 210 via screws or the like).

As with the assemblies 100, 100′, it can be seen that this arrangement provides a simple technique for mounting the RRU 220 onto the antenna 210, simplifies the interconnection of the ports 222 of the RRU to the ports 212 of the antenna 210, and provides covering/protection for cables used to interconnect the ports 212, 222.

Another alternative assembly 200′ is shown in FIG. 14, wherein, as with the assembly 100′, the RRU 220′ has ports 222′ that conform to the “NEX10” convention. An adapter used therewith is similar to the adapter 230, but includes NEX 10-compatible connectors rather than 4.3/10 connectors. A lower mounting bracket 270′ is modified slightly from the lower mounting bracket 270 to fit within the NEX10-configured ports 222′ of the RRU 220′.

The installation of the adapter onto the antenna 210′ is similar to that described above: the adapter is mounted to the antenna 210′ to mate its connectors with the ports 212, then the RRU 220′ is lowered onto the antenna 210′ so that the ports 222′ of the RRU 220′ mate with the connectors of the adapter.

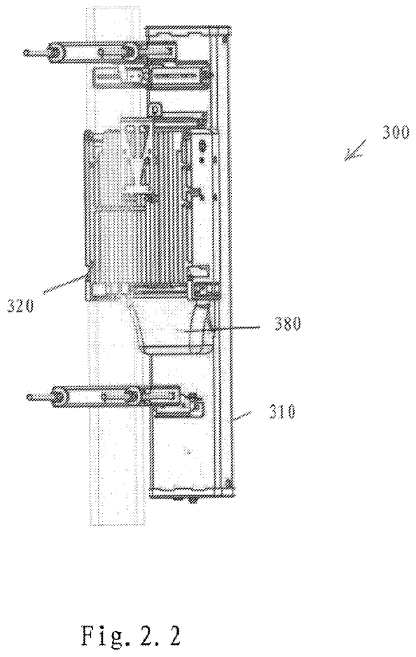

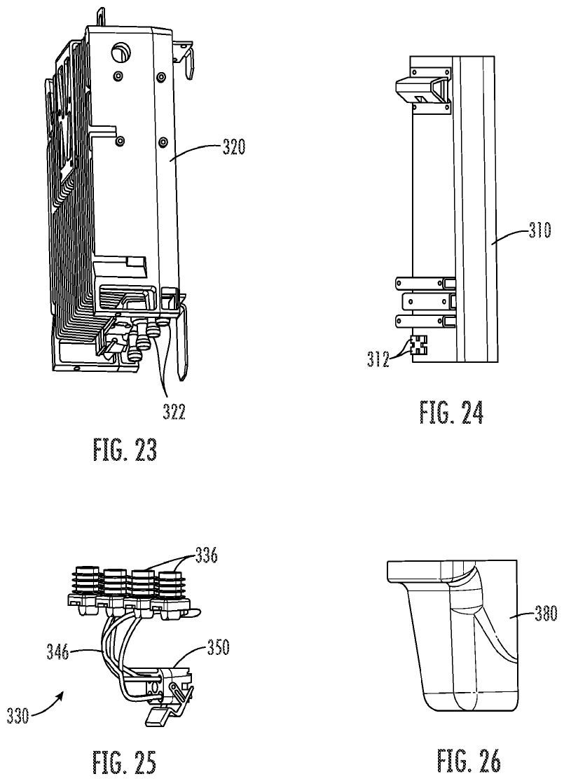

Referring now to FIGS. 22-26, another assembly, designated broadly at 300, is shown therein. The assembly 300 is similar to the assembly 200, with the exception that the adapter 330 (FIG. 25) lacks a housing. The connectors 336 of the adapter are attached to the cluster connector 350 via cables 346. Installation comprises mounting the RRU 320 on the antenna 310, connecting the connectors 336 to ports 322 of the RRU 320, connecting the cluster connector 350 to the port 312 of the antenna 310, then covering the adapter 330 with a cosmetic cover 380 to enclose the cables 346 and the connectors 336, 350. The advantages discussed above in connection with the assemblies 100, 100′, 200, 200′ are equally realizable here.

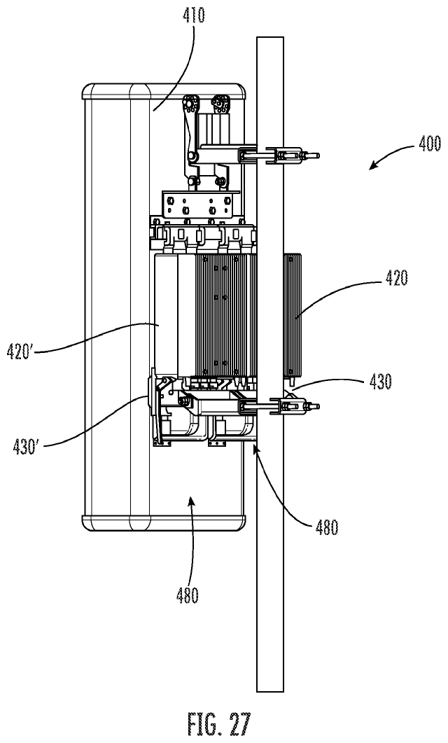

Referring now to FIGS. 27-34, another assembly, designated broadly at 400, is shown therein. The assembly 400 is similar to the assembly 200, with the exception that it includes two RRUs 420, 420′ and two adapters 430, 430′ mounted on an antenna 410 (only one adapter 430 will be described herein). Also, in the assembly 400 the adapters 420 each include a disengagement mechanism 480 that can assist in disassembling of the assembly 400 in the event such disassembly is needed (e.g., if an RRU is to be replaced). The disengagement mechanism 480 is described in greater detail below.

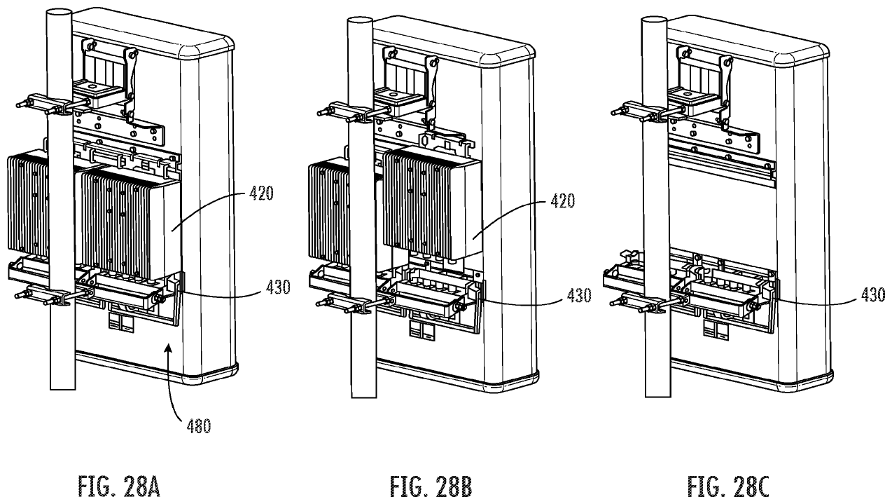

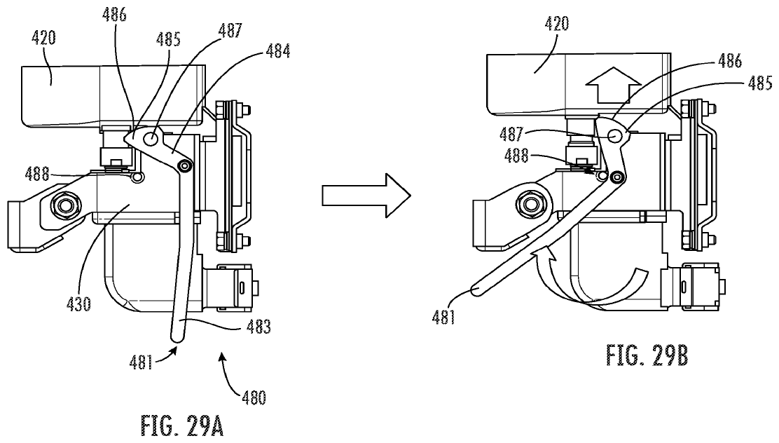

As is seen in FIGS. 28A-28C, when an RRU 420 mounted on the adapter 430 is to be removed (e.g., if it is to be replaced), it is first raised relative to the adapter 430 so that the ports of the RRU 420 are disconnected from the connectors of the adapter 430, then is moved away from the mounted antenna 410. The RRU 420 itself may be heavy (e.g., 50 lbs.), and in addition the force required to disengage the four ports of the RRU 420 from the connectors of the adapter 430 may be as much as 90 lbs. Thus, the overall force required to disengage the RRU 420 from the adapter 430 is considerable.

The disengagement process can be eased by the presence of the disengagement mechanism 480. Referring to FIGS. 29A-29C, the disengagement mechanism 480 includes a generally U-shaped lever 481 with a horizontal handle portion 482 and arms 483 that are disposed generally perpendicular to the handle portion 482. A cam portion 484 extends from the free end of each of the arms 483 (typically the cam portion 484 extends at an angle of between about 40-70 degrees) and includes a two-piece head 485 with arcuate cam surfaces 486 on their upper ends. The lever 481 is mounted to the adapter 420 at pivots 487 that attach the heads 485 on either side of the adapter 430.

As can be seen in FIG. 29A, when the lever 481 of the disengagement mechanism 480 is in its rest position, the handle portion 482 is located below the lower block or cover of the adapter 430. The arms 483 are generally vertically disposed, and the cam portion 484 extends upwardly from the upper ends of the arms 483 and away from the antenna 410. The cam surface 486 is positioned just below the lower surface of the RRU 420. The disengagement mechanism 480 remains in this position during assembly and typical operation.

When a technician wishes to disengage the RRU 420 from the adapter 430, the technician simply grasps the handle portion 482 of the lever 481 and pulls it away from the antenna toward a raised position (see FIG. 29B). This movement rotates the lever 481 about the pivots 486, thereby driving the head 485 upwardly. The cam surface 486 contacts the underside of the RRU 420 and forces it upwardly, which causes the ports of the RRU 420 to disconnect from the connectors of the adapter 430. The length of the arms 483 and the cam portions 484 relative to the head 485 provide a significant mechanical advantage, thus rendering the disengagement of the RRU 420 from the adapter 430 much easier. In some embodiments, and as illustrated herein, a stop projection 488 is located on each side of the adapter 430 to provide a stop for the lever 481 once the RRU 420 is disengaged.

Those of skill in this art will appreciate that the disengagement mechanism 480 may take other forms. For example, the arms 483 and cam portions 484 may together define a straight line, or the angle defined by the arms 483 and the cam portions 484 may differ. The head of the cam portion 485 may have a different shape, such that the cam surface 486 also differs. In some embodiments, the disengagement mechanism may be configured so that the technician pushes the lever toward the antenna to disengage the RRU, rather than pulling the handle away from the antenna. In some embodiments a spring may be included to bias the disengagement mechanism toward the raised position to provide additional assistance in lifting the RRU. Other configurations are also possible.

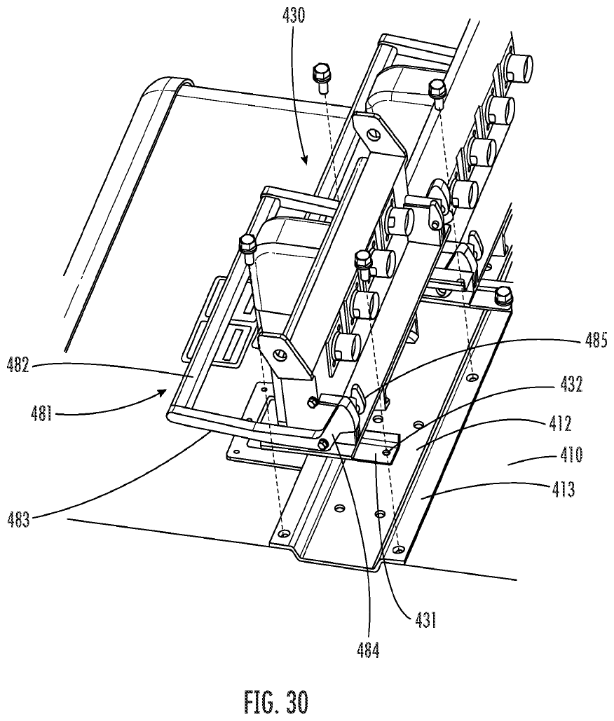

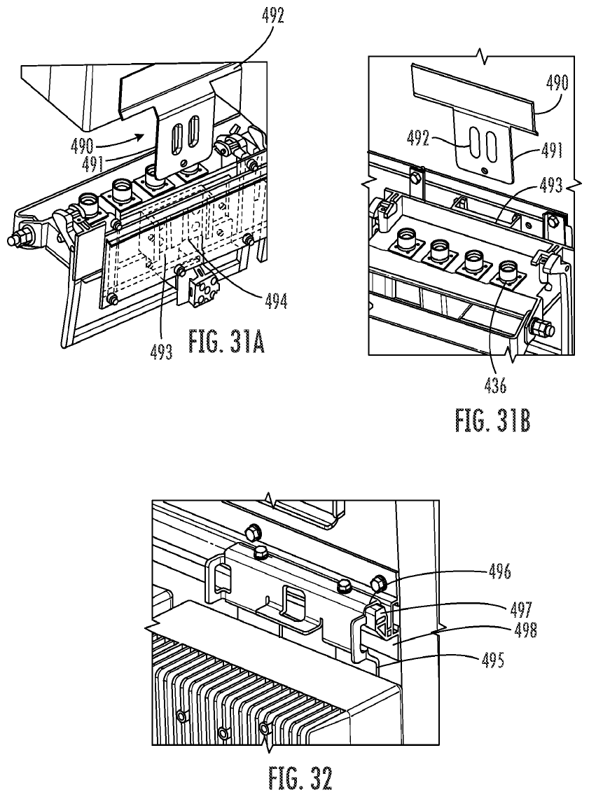

FIG. 30 illustrates how the adapter 430 can be mounted to the antenna 410. More specifically, a channel bracket 412 with flanges 413 is mounted to the rear surface of the antenna 410. Threaded fasteners (e.g., bolts or screws) are then employed through holes 432 on a flange 431 on each side of the adapter 430 to mount the adapter 430 thereto. It can be envisioned that the adapter 430 can be easily replaced with another adapter that is configured to connect with a different RRU 420 (e.g., an RRU from a different manufacturer) should such replacement be required or desired.

As shown in FIGS. 31A and 31B, the mounting of the RRU 420 on the adapter 430 can be further facilitated by the inclusion of a mounting bracket 490. The mounting bracket 490 includes a tongue 491 with raised ribs 492 and is mounted to the lower end of the RRU 420. A block 493 with grooves 494 is mounted on adapter 430. As shown in FIG. 31B, as the RRU 420 is lowered into place, the ribs 492 on the tongue 491 align with the grooves 494 in the block 493. This alignment ensures that the ports of the RRU 420 are correctly aligned with the connectors 436 of the adapter 430. Once in place, the tongue 491 can be fixed to the mounting bracket of antenna 410 or the adapter 430.

The stability of the RRU 420 when mounted can also be enhanced by the inclusion of an upper mounting bracket 495 that includes an upper hook 496 (see FIG. 32). The hook 496 rests on a rail 497 of a mounting bracket 498 on the antenna 410 ad provides a “hard stop” for downward movement of the RRU 420 relative to the antenna 410. This arrangement can maintain the RRU 420 at a desired position relative to the adapter 430 for connection.

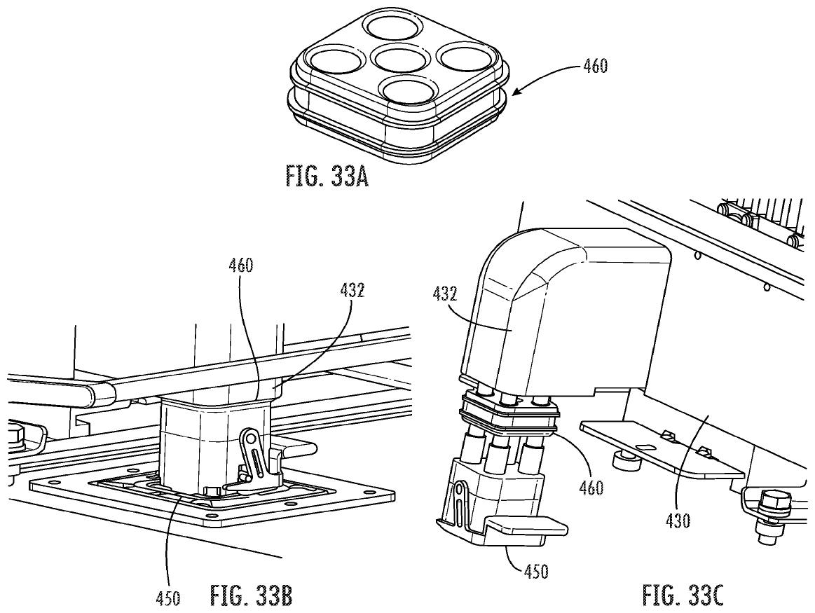

FIGS. 33A-33C illustrate an arrangement in which a resilient insert 460 (typically formed of rubber or a similar elastomeric material) is interposed between the lower block 432 of the adapter 430 and the cluster connector 450 of the adapter 430. The insert 460 can provide vibration absorption/dampening to the connector 450, thereby preventing the generation of any unwanted passive intermodulation (PIM).

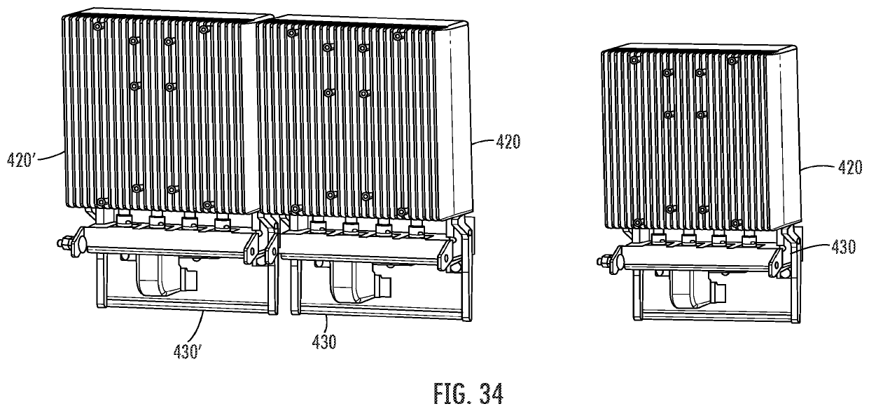

FIG. 34 illustrates that the arrangement discussed in conjunction with the assembly 400 can be used for one or two RRUs (in this instance two RRUs 420, 420′) if a particularly wide antenna 410 is employed.

Some embodiments of the present invention are exemplarily described above in combination with the accompanying drawings. Those of ordinary skill in the art to which the present invention belongs should understand that specific structures shown in the above embodiments are merely exemplary, rather than limiting. Moreover, those of ordinary skill in the art to which the present invention belongs can combine a variety of technical features shown above according to a variety of possible manners to constitute new technical solutions or make other modifications, and these new technical solutions are encompassed within the scope of the present invention.

1. A cellular base station antenna assembly, comprising:
a telecommunications antenna with plurality of first communication ports mounted on a rear surface thereof;
a remote radio unit mounted to the antenna having a plurality of second communication ports on a lower surface thereof; and
an adapter configured to connect the remote radio unit to the antenna, the adapter including a housing, a first clustered connector that includes a plurality of individual first connectors, the first clustered connector being mounted on a lower portion of the housing, the adapter further including a plurality of second connectors mounted on an upper surface of the housing, each of the first connectors being connected with a respective second connector;
wherein each of the second connectors is mated with a respective second communication port, and each of the first connectors is mated with a respective first communication port;
wherein the assembly further comprises a disengagement mechanism connected to the assembly and configured to raise the remote radio unit relative to the adapter to disengage the second connectors from the second communication ports.

2. The assembly defined in claim 1, wherein the first communication ports are mounted in a second clustered connector that is mounted to the antenna, and wherein the first clustered connector is mated to the second clustered connector.

3. The assembly defined in claim 1, wherein the first connectors are blind mated connectors.

4. The assembly defined in claim 1, wherein the second connectors are blind mated connectors.

5. The assembly defined in claim 1, wherein the first connectors and the second connectors are blind mated connectors.

6. The assembly defined in claim 2, wherein the second clustered connector is mounted to the antenna such that the first communication ports face upwardly.

7. The assembly defined in claim 2, wherein the second clustered connector is mounted to the antenna so that the first communication ports face rearwardly.

8. The assembly defined in claim 1, wherein the second connectors are 4.3/10 connectors.

9. The assembly defined in claim 1, wherein the second connectors are NEX10 connectors.

10. The assembly defined in claim 1, wherein the remote radio unit includes an upper mounting bracket that engages an upper bracket on the antenna.

11. The assembly defined in claim 10, wherein the adapter includes a lower mounting bracket that engages a lower bracket on the antenna.

12. The assembly defined in claim 10, wherein the remote radio unit includes a lower mounting bracket that engages a lower mounting bracket on the antenna, and wherein the lower mounting bracket includes a tongue that engages a block in the adapter.

13. (canceled)

14. A cellular base station antenna assembly, comprising:
a telecommunications antenna having a plurality of first communication ports mounted on a rear surface thereof;
a remote radio unit mounted to the antenna having a plurality of second communication ports on a lower surface thereof; and
an adapter configured to connect the remote radio unit to the antenna, the adapter including a first clustered connector that includes a plurality of individual first connectors, the adapter further including a plurality of second connectors, each of the first connectors being connected with a respective second connector by a respective cable;
wherein each of the second connectors is mated with a respective second communication port, and each of the first connectors is mated with a respective first communication port;
the assembly further comprising a cover mounted to the antenna that encloses the cables, the second clustered connector and the first connectors;
wherein the assembly further comprises a disengagement mechanism connected to the assembly and configured to raise the remote radio unit relative to the adapter to disengage the second connectors from the second communication ports.

15. The assembly defined in claim 14, wherein the first communication ports are mounted in a second clustered connector that is mounted to the antenna, and wherein the first clustered connector is mated to the second clustered connector.

16. The assembly defined in claim 14, wherein the first connectors are blind mated connectors.

17. The assembly defined in claim 14, wherein the second connectors are blind mated connectors.

18. The assembly defined in claim 13, wherein the first connectors and the second connectors are blind mated connectors.

19. The assembly defined in claim 15, wherein the second clustered connector is mounted to the antenna so that the first communication ports face rearwardly.

20. The assembly defined in claim 14, wherein the second connectors are 4.3/10 connectors or NEX10 connectors.

21. (canceled)

22. The assembly defined in claim 14, wherein the remote radio unit includes a lower mounting bracket that engages a lower mounting bracket on the antenna, and wherein the lower mounting bracket includes a tongue that engages a block in the adapter.

23. (canceled)
